(19) United States
(12) Patent Application Publication
(10) Pub. No.: US 2017/0236402 A1
(43) Pub. Date: Aug. 17, 2017

(54) INTERCONNECT BASE FOR INTERCONNECTED SENSOR

(71) Applicant: Apollo America Inc., Auburn Hills, MI (US)

(72) Inventor: Rochelle McGee, Waterford, MI (US)

(21) Appl. No.: 15/042,237

(22) Filed: Feb. 12, 2016

(51) Int. Cl. G08B 25/08; G08B 17/10

(52) U.S. Cl. CPC G08B 25/08; G08B 17/10

(57) ABSTRACT

An adapter base for use with a hazardous condition detector system. The system includes a plurality of detectors (alarms) that are operable to detect at least one hazardous condition in a physical structure such as a building and a control panel that is not electronically compatible with the detectors. At least one adapter base is communicatively coupled to at least one of the plurality of detectors and the control panel. The at least one adapter base can sense an alarm signal from the at least one of the plurality of detectors and transmit an alert signal to the control panel, thereby communicatively coupling all of the plurality of detectors with the control panel.

### CROSS-REFERENCE TO RELATED APPLICATIONS

This application claims priority of U.S. Provisional Patent Application Ser. No. 62/116,591 filed Feb. 16, 2015, which is incorporated herein in its entirety by reference.

### FIELD OF TEE INVENTION

The present invention is related to an adapter for use with a hazardous condition detector or alarm and in particular to an adapter that provides compatibility between one or more hazardous condition detectors and a control panel.

### BACKGROUND OF THE INVENTION

Interconnected sensors s such as a plurality of interconnected smoke detectors, gas or a combination of smoke/gas detectors interconnected on a common input, such as a household 120 AC power circuit are known. Such interconnect-capable sensors can be desirable since they provide a facility for when one of the sensors enters an alarm state and provides an alarm signal, the alarm state can be communicated to all sensors, which can provide an alarm signal/alert. However, when desired that additional sensors and/or a control panel that an communicate with an outside entity are to be added to a set of interconnected sensors, it is not uncommon that the additional sensors and/or control panel fail to be compatible with the original sensors. It can be necessary to replace the original interconnected sensors to upgrade a facility and that replacement of sensors still in an operating condition can be undesirable. Therefore, an apparatus or device that provides compatibility between newly installed sensors and/or a control panel and previously installed interconnected sensors would be desirable.

### SUMMARY OF THE INVENTION

An adapter base for use with one or more hazardous condition detectors (detectors) in a building is provided. It should be appreciated that a hazardous condition detector is also known as a hazardous condition alarm. The one or more detectors are operable to detect at least one hazardous condition in the building and produce an alarm signal. If more than one detector is provided, the detectors are interconnected to each other (interconnected) through or with a common/shared circuit. The system also includes at least one adapter base that is coupled to at least one detector such that an adapter base is communicatively coupled with the common/shared circuit and at least one of the detectors. As used herein, the term “communicatively coupled” means that coupled components are capable of exchanging data signals with one another such as, for example, electrical signals via conductive medium, over-the-air electromagnetic signals, optical signals via optical waveguides, and the like. The common/shared circuit can serve as and/or include a signal wire that connects the plurality of detectors to each other. The common/shared circuit of the detectors can be a 120 VAC circuit that provides power to the detectors. The common/shared circuit and/or signal wire affords all of the detectors to produce an alarm signal when one of the detectors detects a hazardous condition and produces an alarm signal. A control panel that is operable communicate with and transmit an alert signal to an off-site facility, but is not electronically compatible with and operable to receive an alarm signal from the detectors, is also included. The control panel is a receiver of an alert signal from the one or more adapter bases and a transceiver of a warning signal to the off-site facility. An adapter base coupled to a detector is operable to receive the alarm signal from the detector and transmit an alert signal to the control panel. The control panel can then receive and process the alert signal and transmit a warning-signal to the off-site facility. In this manner, a control panel can be installed in a building without having to replace on or more detectors that are already present in the building, still functional to detect a hazardous condition, but not electronically compatible with the control panel.

In some instances, only one adapter base is included in a common/shared circuit that contains a plurality of detectors and the one adapter base is communicatively coupled with one of the detectors. In such instances, when one detector produces an alarm signal, the alarm signal is transmitted to all of the detectors in the circuit and all of the detectors produce an alarm signal. When the detector having the adapter base coupled thereto produces an alarm signal, the adapter base receives the alarm signal from the coupled detector and transmits the alert signal to the control panel. In this manner, all of the detectors communicatively coupled to the control panel.

The detector can be a smoke detector, a smoke alarm, a heat detector, a heat alarm, a gas detector (such as carbon monoxide), a gas alarm, or combination smoke, heat and/or gas detector/alarm (combination detector/alarm). The one or more adapter bases can be in communicatively coupled with common/shared circuit via an electrical wire spliced to the common/shared circuit or, in the alternative, via an electrical wire connected to the common/shared circuit through an electrical plug.

The one or more detectors can have their own base that affords for each detector to be attached to the building. For example, the plurality of detectors with corresponding bases can already be present and functioning within a building before the adapter bases are provided and installed. In addition, the one or more adapter bases can be configured such that a given detector and its base are attached or coupled to a given adapter base and thus a new detector base is not required for installation of the adapter base or the control panel. For example, each detector base can have a first aperture and a threaded fastener, the threaded fastener extending through the first aperture and attaching the base and detector to the building. As such, each adapter base can have a second aperture in alignment with the first aperture of the detector base and the threaded fastener can extend through the first and second apertures such that the base, the adapter base, and the detector are attached to the building.

The adapter base can have its own electronic circuit. The electronic circuit can be operable to receive an alarm signal from a respective detector and then transmit an alert signal to the control panel. The respective detector can transmit the alert signal to the control panel via the common/shared circuit and/or through a wireless communication system. Stated differently, the electronic circuit of each adapter base provides compatibility between a detector and the control panel.

A process for installing a control panel is also disclosed herein. The process includes providing one or more detectors that are operable to detect at least one hazardous condition. The one or more are located within a physical structure such as a building. When a plurality of detectors is provided, the plurality of detectors have a common/shared circuit that connects the detectors to each other such that when one of the plurality of detectors detects a hazardous signal and produces an alarm signal, all of the plurality of detectors produce their own alarm signal. Stated differently, the plurality of detectors are interconnected. A control panel for the plurality of detectors also provided but the control panel is not electronically compatible with the plurality of detectors. For example, new detectors that are not compatible with an existing control panel can be installed a building, or a new control panel that is not compatible with existing detectors can be installed in or proximate to a building.

One or more adapter bases is provided and coupled to at least one detector such that at least one adapter base is physically and communicatively coupled with at least one detector. The one or more adapter bases electronically compatible with the plurality of detectors and also compatible with the control panel. The one or more adapter bases are connected to the common/shared circuit and are thus operable to receive an alarm signal from a respective detector coupled thereto and transmit an alert signal to the hazardous condition control panel. As such, a single adapter base can be communicatively coupled with all of the detectors and thus communicatively couple all of the plurality detectors with the control panel 200, an outside entity, etc.

With the connection of at least one adapter base to the common/shared circuit and with the control panel being electronically compatible with the adapter base, the control panel is operable to receive and process the alert signal from the at least one adapter base and transmit a warning-signal to an off-site facility, e.g., an off-site receiver, app, etc. In this manner, a new control panel can be installed for an existing plurality of detectors within a physical structure and the plurality of detectors, which are not electronically compatible with the control panel, do not have to be replaced since the one or more adapter bases provide compatibility therebetween.

### BRIEF DESCRIPTION OF THE DRAWINGS

FIG. 1 is a schematic illustration of a prior art interconnected detector in the form of a smoke detector;

FIG. 2 is a schematic illustration of a plurality of interconnected detector and an optional control panel;

FIG. 3 is a schematic illustration of an interconnect base (also referred to herein as an “adapter base”) for an interconnected detector according to an aspect disclosed herein;

FIG. 4 is an exploded view of the adapter base shown in FIG. 3;

FIG. 5 is a top view of the adapter base shown in FIG. 4 illustrating electronic circuitry and a wire harness according to an aspect disclosed herein;

FIG. 6 is a top view of the adapter base shown in FIG. 4 illustrating electronic circuitry and a wire harness according to another aspect disclosed herein;

FIG. 7 is a schematic diagram for electronic circuitry that is part of the adapter base according to an aspect disclosed herein; and

FIG. 8 is a schematic illustration of a process for installing a hazardous condition control panel according to an aspect disclosed herein.

### DETAILED DESCRIPTION OF THE INVENTION

This disclosure broadly relates to an electronic device that ensures compatibility or communication between one interconnect-compatible hazardous condition detector (hereafter also referred to as a “detector”) and a control panel, and also between the one detector and other multiple detectors and the control panel. The electronic device can be in the form of an interconnect base (also referred to herein as an “adapter base”) which is described in greater detail below, however this is not required. In addition, the electronic device can communicate with a control panel such that the control panel can further communicate a signal, such as a warning-signal to additional devices, personnel, etc. In addition, the electronic device may or may not itself communicate an alert signal to the control panel additional devices, personnel, etc. For the purposes of the instant disclosure, the term “warning-signal” refers to a signal transmitted by the control panel, the term “alert signal” refers to a signal transmitted by the adapter base, and the term “alarm signal” refers to a signal transmitted by a detector.

The electronic device can include an electronic circuit that is formed of small components such as integrated circuits and semiconductors. As such, the electronic circuit can be enclosed within a housing that can be, e.g., part of an adapter base. The electronics are powered by a common/shared circuit itself, e.g. a 120 VAC electrical circuit, or in the alternative can be powered by one or more battery cells contained within the electronic circuit during a power failure of the interconnect circuit.

The electronic circuit may perform a variety of functions, such as sensing alarm signals generated by a detector. It may also transmit its own alert signals to associated equipment, control panels for safety devices, and/or possibly Internet signals to websites having URLs stored in the electronic circuitry.

In some instances, the detector can be a smoke detector, a heat detector, a gas detector, a combination of a smoke detector, a heat detector and/or gas detector, which generates an audible signal when at least one hazardous condition is sensed. Presently, such detectors suffer from the fact that alarm conditions may occur at a time when there are no personnel in the building or those persons in the building are not sufficiently close to the electronic device to hear the audible signals. As such, a control panel or similar device can be installed that can relay or transmit such alarm signals to offsite organizations or personnel, such as fire departments, owners of a home, facility, and the like. In addition, the electronic device might transmit its own alarm signals to offsite organizations, personnel, etc. or other electrically compatible devices connected to the control panel.

The electronic device disclosed herein can sense the detector going into an alarm condition, possibly by incorporating microphones or vibration sensors which sense the audible signals, or by measuring the current draw from the power source, such as the common shared circuit.

When the electronic circuitry of the electronic device detects that its connected detector has sensed an alarm condition, it may relay that condition in another device such as a control panel disposed in the same building, a remote alarm, or even a remote location. This may be done by a wired connection extending from the electronic device or by some wireless transmission such as RF, infrared, or the like to a remote receiver. This wireless transmission could take the form of a cell phone or Wi-Fi type of transmission to a designated URL on the Internet.

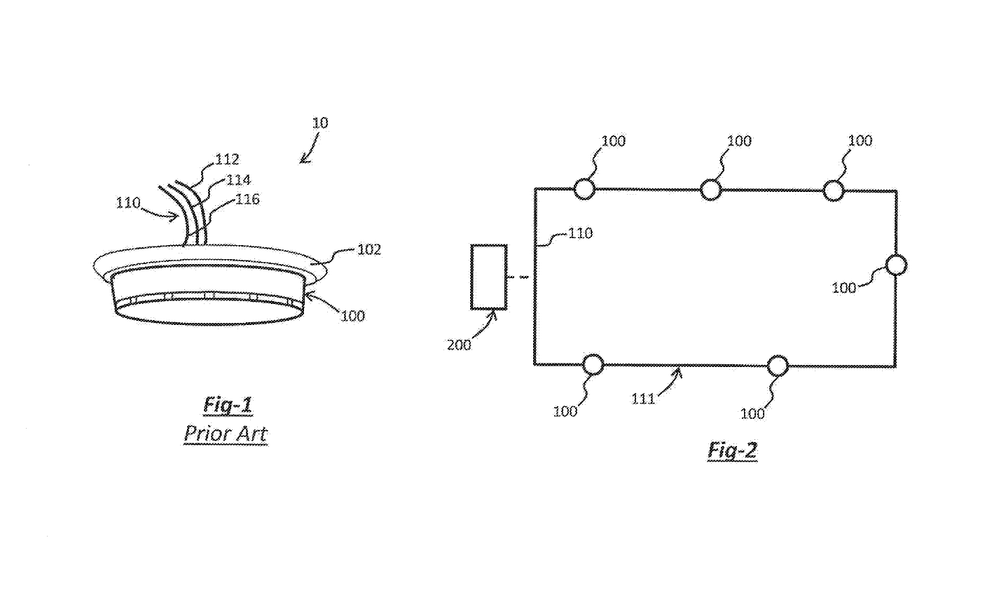

Turning now to FIG. 1, a prior art interconnect detector is shown generally at reference numeral 10. For example and for illustrative purposes only, the interconnect detector is in the form of a smoke detector 100 having a baseplate 102 and interconnect wiring 110. The baseplate typically aids in mounting of the smoke detector to a physical structure such as a ceiling, wall, etc. The wiring 110 can include a hot terminal wire 112, a neutral terminal wire 114, and a ground wire 116 that affords for signal transmission with and between additional detectors 100. For example, FIG. 2 illustrates a plurality of smoke detectors 100 in communication with each other via the wiring 110 and a common/shared circuit 111 that also has a hot wire (not shown), a neutral wire (not shown) and a ground wire (not shown). In this manner, if a single smoke detector 100 enters into an alarm state, then the alarm state can be communicated (e.g. via an alarm signal) to the remainder of smoke detectors 100 via the interconnect wiring 110 and common/shared circuit 111.

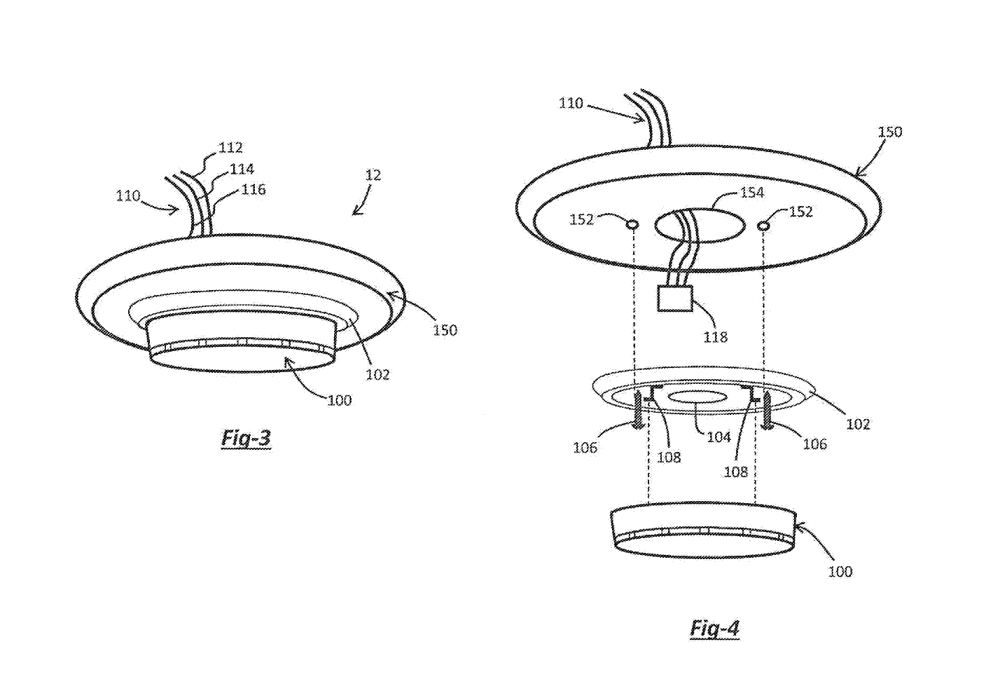

In some instances, it is desired that when an alarm state is entered, that communication to offsite organizations or personnel is provided. As such, a control panel or similar device 200 that can communicate with off-site facilities, organizations, personnel, etc., can be installed and put into communication with the one or more smoke detectors 100. However, it is also possible that a desired control panel 200 is not compatible with one or more of the detectors 100. For example, a desired panel or device 200 that can communicate or send alarm signals to fire and safety patrol personnel, owners of the panel, owners of the facility, and the like may not necessarily be able to receive an alarm signal from one or more of the detectors 100. Therefore, and as opposed to replacing the detectors 100 with other detectors that are compatible with the control panel 200, an inventive adapter base 150 as shown in FIG. 3 can be installed.

As shown generally in FIG. 3 at reference numeral 12, the adapter base 150 is included with the detector 100 and baseplate 102. As shown in the exploded view in FIG. 4, the detector 100 with the baseplate 102 attaches to a physical structure such as a ceiling, wall, etc. (not shown) through the adapter base 150. For example and for illustrative purposes only, the baseplate 102 can be attached to the base structure through the adapter base 150 via a pair of threaded fasteners 106 that pass through apertures (not shown) of the baseplate 102, through apertures 152 of the adapter base 150, and into the physical structure.

The baseplate 102 can have a central aperture 104 and the adapter base 150 can also have a central aperture 154. The wiring 110 can pass through the central aperture 154, through the central aperture 104, and connect to the detector 100 as illustrated in FIG. 1. As such, the adapter base 150 can be installed with a preexisting detector 100 and its baseplate 102 using the same wiring 110. It is appreciated that the wiring 110 can have a terminal plug 118 that affords electrical connection with the detector 100. It is also appreciated that the baseplate 102 can nest within and/or up against the adapter base 150.

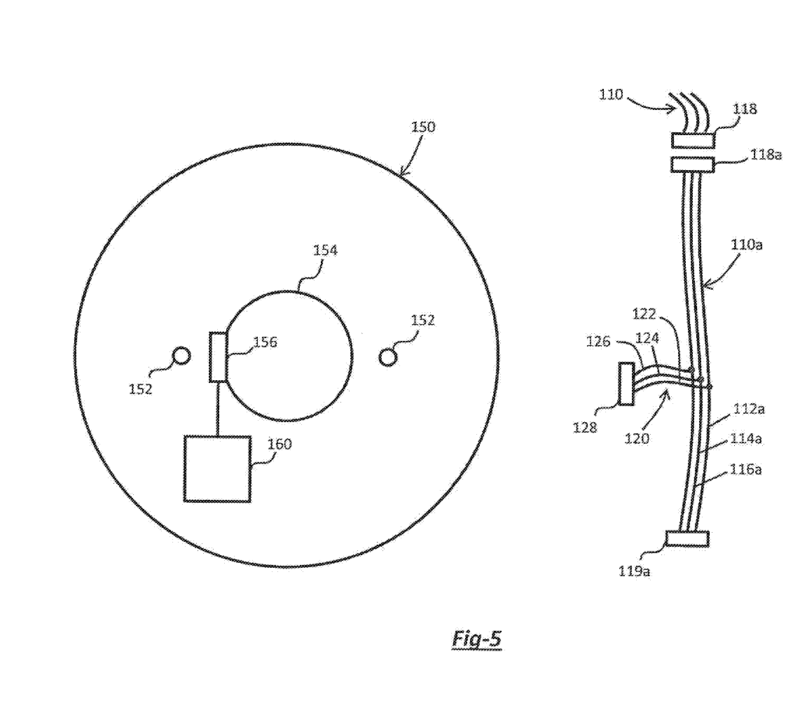

Regarding interconnecting the adapter base 150 with the detector 100 and the wiring 110, FIG. 5 illustrates an aspect in which a wiring harness 110a is used to connect to the wiring 110, the adapter base 150, and the detector 100. In particular, the wiring harness 110a has an electrical plug 118a which is complementary with the terminal plug 118 and thus allows electrical connection therebetween. The wiring harness 110a has a hot terminal wire 112a, a neutral terminal wire 114a, and a ground wire 116a, as well as a terminal plug 119a which can electrically connect to the detector 100, as can terminal plug 118. Also, the wiring harness 110a has an adapter base portion 120 with a hot terminal wire 122, a neutral terminal wire 124, and a ground wire 126. The three wires 122-126 are electrically connected to the wires 112a, 114a, and 116a, respectively, and also to a plug 128.

The adapter base 150 has a plug 156 which is in electrical connection with an electronic circuit 160, which may or may not be a miniaturized electronic circuit. Also, the plug 128 of the wiring harness 110a is complementary with the plug 156 and thus affords for electrical connection between the adapter base 150, the detector 100, and the wiring 110.

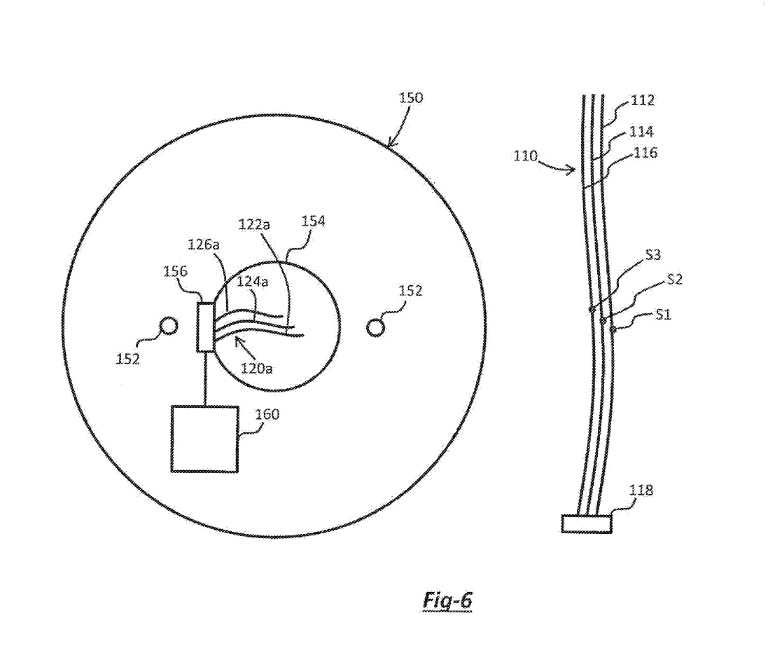

Another embodiment of the connection of the adapter base 150 with the wiring 110 and the detector 100 is shown in FIG. 6. In particular, the adapter base 150 has a hot wire 122a, a neutral wire 124a, and a ground wire 126a extending from the plug 156. However, in this embodiment, the three wires 122a-126a are simply spliced into the three wires 112, 114, 116, respectively, of the wiring 110, for example at splice locations S1, S2, S3, respectively. In addition, the plug 118 is connected with the detector 100 and thus the adapter base 150 is electrically connected with detector 100 and the common/shared circuit 111. It is appreciated that such an adapter base 150 would be in electrical connection with all of the detectors 100 shown in FIG. 2. Therefore, a single adapter base 150 can put all of the plurality detectors 100 into communication with the control panel 200, and thus into communication with an outside entity, etc. It is also appreciated that the embodiment shown in FIG. 6 does not require the plug 156, i.e. the three wires 22a-126a can be connected directly to the electronic circuit 160.

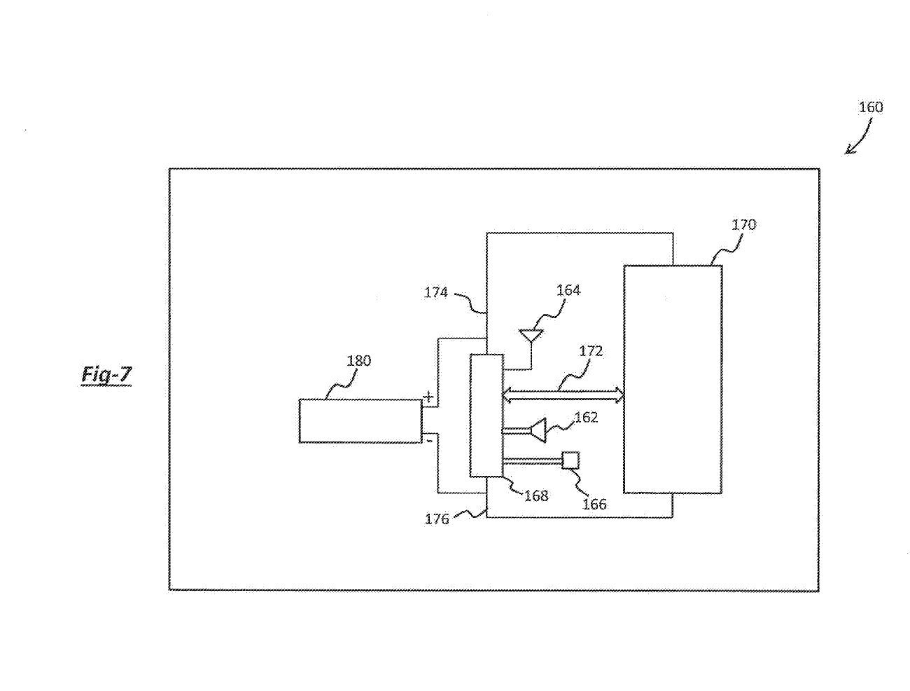

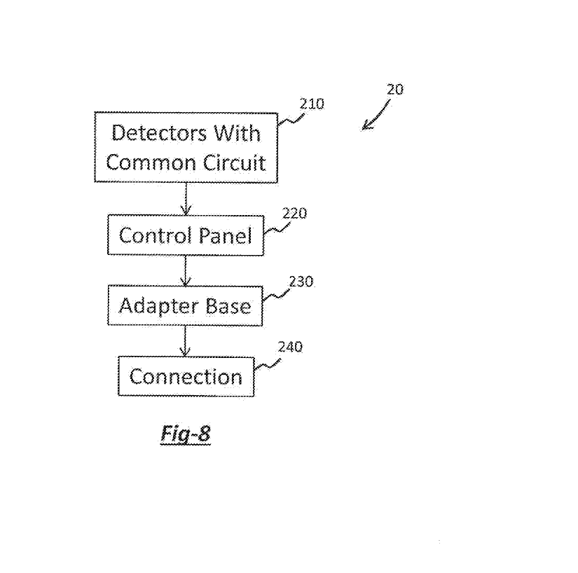

The electronic circuit 160 is shown schematically in FIG. 7. The electronic circuit 160 includes a sensor 162, e.g. a microphone or vibration sensor which senses audible signals, or senses a current draw through the interconnect circuit. The electronic circuit 160 also includes an antenna/transmitter 164 that can transmit an alert signal to the control panel 200 and/or offsite organizations or personnel, such as fire departments, owners of a home, facility, and the like. Both the sensor 162 and antenna 164 are electronically connected with communication electronics 168, which in turn is in electrical connection with the common/shared circuit 111 via external wired interface 166, plug 156 and wiring 110 or wiring harness 110a. The electronic circuit 160 can also have a backup battery source 180 that supplies power to the electronics in the event of a power outage to common/shared circuit 111.

The communication electronics 168 are electronically connected with device electronics 170, which can have memory with one or more internet URL addresses and/or email addresses such that an alert signal can be transmitted over the interne using the control panel 200 and/or the adapter base 150 itself, one or more telephone numbers such that a text message can be sent using the control panel 200 and/or the adapter base 150 itself. In some instances, the device electronics 170 may receive a responsive acknowledgement signal after an alert signal has been transmitted, which in turn would stop the audible alarm or perform other actions such as changing the sound of the audible sensor or switching the auxiliary external power supplies for the alarm, etc.

Turning now to FIG. 8, a process for installing a control panel according to an aspect disclosed herein is shown generally at reference numeral 20. The process 20 includes providing one or more detectors that are connected to a hardwired 120 VAC circuit and interconnected with each other at step 210. The one or more detectors can be located within a physical structure such as a building. A control panel is provided at step 220 and can be installed within or proximate to the building. One or more adapter bases are provided at step 230. The one or more adapter bases provided at step 230 are connected to the 120 VAC circuit and to at least one of the detectors at step 240. As such, when one of the detectors provides an alarm signal, all of the detectors provide an alarm signal and each adapter base that is coupled with a detector receives the alarm signal and then sends an alert signal to the control panel. The control panel, being compatible with each adapter base, can then receive the alert signal, process it, and transmit a separate signal, e.g. a warning-signal, to an off-site facility. In this manner, an existing physical structure with a plurality of detectors can be upgraded with a control panel even if the control panel is not electronically compatible with the detectors.

The examples, embodiments, etc. described above are for illustrative purposes only and are not meant to and do not limit the scope of the invention. Changes, modifications, and the like will be apparent to those skilled in the art and yet still fall within the scope of the invention. It is the claims, and all equivalents thereof, that define the scope of the invention.

I claim:

1. An adapter for use with a hazardous condition detector system in a building comprising:
one or more detectors operable to detect at least one hazardous condition in the building and produce an alarm signal, said one or more detectors interconnected with a common/shared circuit;
at least one adapter base coupled to one of the one or more detectors; and
a control panel operable to transmit a warning signal to an off-site facility, said control panel not compatible with and operable to receive the alarm signal from said one or more detectors;
said at least one adapter base being in communicatively coupled with said common/shared circuit and electronically compatible with said control panel;
said at least one adapter base operable to receive said alarm signal from said one or more detectors coupled thereto and transmit a alert signal to said control panel, said control panel operable to receive and process said alert signal and transmit said warning signal to the off-site facility.

2. The adapter of claim 1, wherein one or more detectors is selected from at least one of a smoke detector, a heat detector, a gas detector and a combination detector.

3. The adapter of claim 2, wherein said at least one adapter base is communicatively coupled with said common/shared circuit via a electrical wire connected thereto.

4. The adapter of claim 3, wherein said electrical wire is spliced to said common/shared circuit.

5. The adapter of claim 3, wherein said electrical wire is connected to said common/shared circuit through an electrical plug.

6. The adapter of claim 3, further comprising each of said one or more detectors having a baseplate and each of said at least one adapter base coupled to a detector through said baseplate.

7. The adapter of claim 6, wherein said baseplate has a first aperture and a threaded fastener, said threaded fastener extending through said first aperture and attaching said baseplate to the building.

8. The adapter of claim 7, wherein said at least one adapter base has a second aperture in alignment with said first aperture, said threaded fastener extending through said first aperture and said second aperture and attaching said baseplate and said at least one adapter base to the building.

9. The adaptor of claim 8, wherein said at least one adapter base has an electronic circuit, said electronic circuit operable to receive said alarm signal from said detector and transmit said alert signal to said control panel.

10. A method for installing a control panel, the process comprising:
providing a plurality of detectors operable to detect at least one hazardous condition, the plurality of detectors located within a physical structure and interconnected via a common/shared circuit each other such that when one of the plurality of detectors detects a hazardous condition and produces an alarm signal all of the plurality of detectors produce the alarm signal;
providing the control panel for the plurality of detectors, the control panel not electronically compatible with the plurality of detectors;
providing an adapter base, the adapter base physically and communicatively coupled to one of the plurality of detectors, the adapter base electronically compatible with the control panel;
connecting the adapter base to the common/shared circuit,
wherein the adapter base is operable to receive the alarm signal from the one of the plurality of detectors and transmit an alert signal to the control panel, the control panel operable to receive and process the alert signal and transmit a warning-signal to an off-site facility.

11. The method of claim 10, wherein the plurality of detectors are selected from at least one of a plurality of smoke detectors, a plurality of heat detectors, a plurality of gas detectors and a plurality of combination detectors.

12. The method of claim 11, wherein the adapter base is communicatively coupled to the common/shared circuit through electrical wire spliced into the common/shared circuit.

13. The method of claim 11, wherein the adapter base is communicatively coupled to the common/shared circuit through electrical wire with an electrical plug, the electrical plug electrically connected to the common/shared circuit.
